(19) United States
(12) Patent Application Publication
(10) Pub. No.: US 2007/0223026 A1
(43) Pub. Date: Sep. 27, 2007

(54) Printing System, Information-Processing Apparatus and Method, Computer-Readable Medium, and Computer Data Signal

(75) Inventor: Takashi Hashizume, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/563,811

(22) Filed: Nov. 28, 2006

(30) Foreign Application Priority Data
Mar. 27, 2006 (JP) 2006-084795

(51) Int. Cl. G06F 3/12

(52) U.S. Cl. 358/1.13

(57) ABSTRACT

A printing system has an information processing apparatus and a printing apparatus, wherein the information processing apparatus includes: an extraction section that extracts a cross reference table and a trailer from a PDF file to be printed; and a transmission section that first transmits the extracted cross reference table and the trailer to the printing apparatus, and then transmits a body of the PDF file, and wherein the printing apparatus includes: a reception section that receives the cross reference table and the trailer from the information processing apparatus and then receives the body; and a print processing section that starts print processing of the PDF file without waiting for completion of receipt of the body, by using the received cross reference table and the trailer.

### PRIORITY INFORMATION

This application claims priority from Japanese Patent Application No. 2006-084795, filed on Mar. 27, 2006.

### BACKGROUND

1. Technical Field

The present invention relates to a printing system, an information processing apparatus, a printing apparatus and method, a computer-readable medium, and a computer data signal.

2. Related Art

There is a printing apparatus provided with a function (called a PDF direct print function) of directly printing a PDF (Portable Document Format) file. In this kind of printing apparatus, the PDF file does not have to be converted into PDL (Page Description Language) data in a personal computer (PC), whereby shortening of printing time or the like is realized.

However, in the printing apparatus, in order to analyze and print the PDF file, the entire PDF file must be received, and a cross reference table and a trailer described at the end of the PDF data are read out.

### SUMMARY

According to one aspect of the present invention, there is provided a printing system having an information processing apparatus and a printing apparatus, wherein the information processing apparatus includes: an extraction section that extracts a cross reference table and a trailer from a PDF file to be printed; and a transmission section that first transmits the extracted cross reference table and the trailer to the printing apparatus, and then transmits a body of the PDF file, and wherein the printing apparatus includes: a reception section that receives the cross reference table and the trailer from the information processing apparatus and then receives the body; and a print processing section that starts print processing of the PDF file without waiting for completion of receipt of the body, by using the received cross reference table and the trailer.

### BRIEF DESCRIPTION OF THE DRAWINGS

Exemplary embodiment of the present invention will be described in detail based on the following figures, wherein:

FIG. 1 is a block diagram showing a structure of a printing system according to an exemplary embodiment;

FIG. 2 is a view showing a rough structure of a PDF file;

FIG. 3 is a flowchart showing an operation procedure of a PC;

FIG. 4 is a view showing a rough structure of data transmitted to a printing apparatus from a PC in PDF post-analysis transmission processing; and

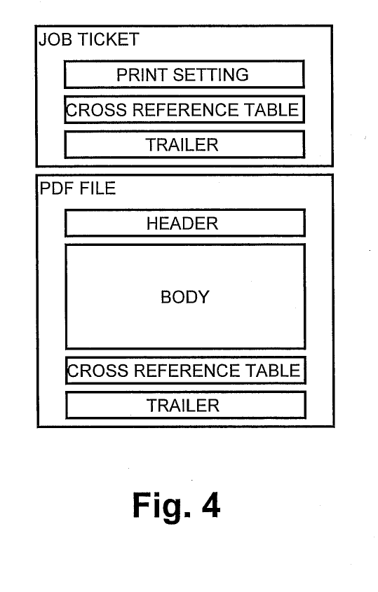

FIG. 5 is a flowchart showing an operation procedure of the printing apparatus.

### DETAILED DESCRIPTION

Hereinafter, exemplary embodiment of the invention will be described with reference to the drawings.

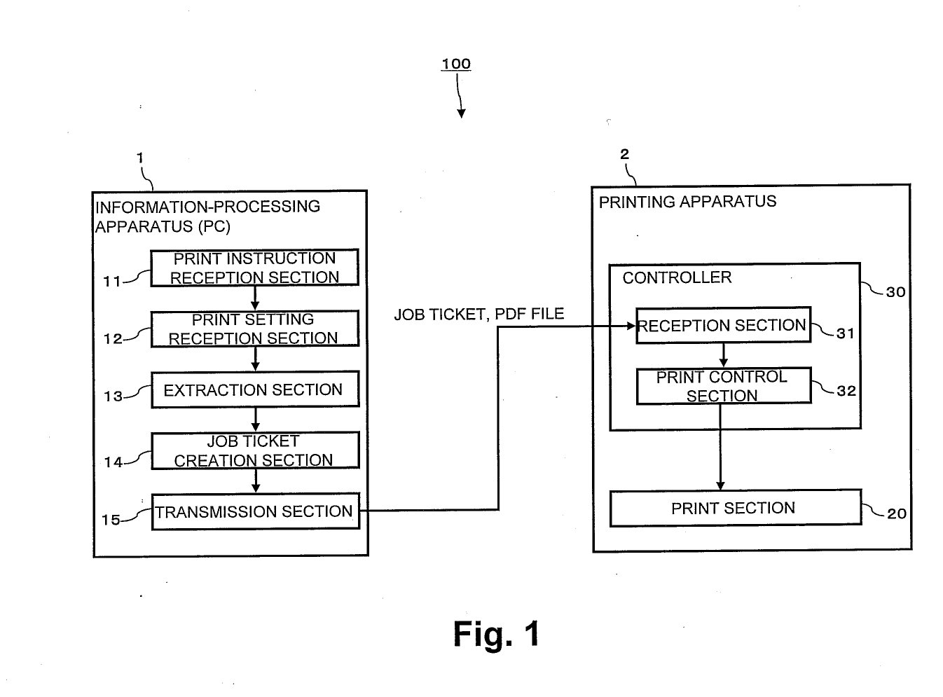

FIG. 1 is a block diagram showing the structure of a printing system 100 according to the exemplary embodiment. This printing system 100 realizes direct printing of a PDF file. In FIG. 1, the printing system 100 includes an information-processing apparatus 1 and a printing apparatus 2. The information processing apparatus 1 and the printing apparatus 2 are connected to each other through a network such as a LAN (Local Area Network). However, the information-processing apparatus 1 and the printing apparatus 2 may be locally connected to each other.

The information-processing apparatus 1 is a client apparatus for transmitting a print request to the printing apparatus 2. In this exemplary embodiment, the information-processing apparatus 1 is a personal computer (PC), and is realized by the cooperation of software and hardware resources. The information-processing apparatus 1 includes, as the software, an OS (Operating System), utility software for performing the direct printing of the PDF file, and the like, and includes, as the hardware resources, a CPU (Central Processing Unit), a main memory, ROM (Read Only Memory), an external memory device such as a hard disk, an input device such as a keyboard or a mouse, an output device such as a liquid crystal display, and the like. The function of the information-processing apparatus 1 is realized in such a manner that a program recorded on a recording medium such as the external memory device or the ROM is read into the main memory and is executed by the CPU. Incidentally, in the following description, the information-processing apparatus 1 will be referred to as the PC 1.

The printing apparatus 2 is a printer for performing print processing in accordance with a print request from the PC 1, and has the PDF direct print function. In FIG. 1, the printing apparatus 2 includes a print section 20 and a controller 30.

The print section 20 is a device, a so-called IOT (Image Output Terminal), for printing an image on a recording medium, such as paper, by means of a suitable printing system such as an electrophotographic system.

The controller 30 controls the entire printing apparatus 2. In this exemplary embodiment, the controller 30 is a circuit board on which a CPU (Central Processing Unit), ROM (Read Only Memory), a main memory, NVRAM (Non Volatile RAM) and the like are mounted, and its function is realized in such a manner that a program recorded on a recording medium such as the ROM is read into the main memory and executed by the CPU.

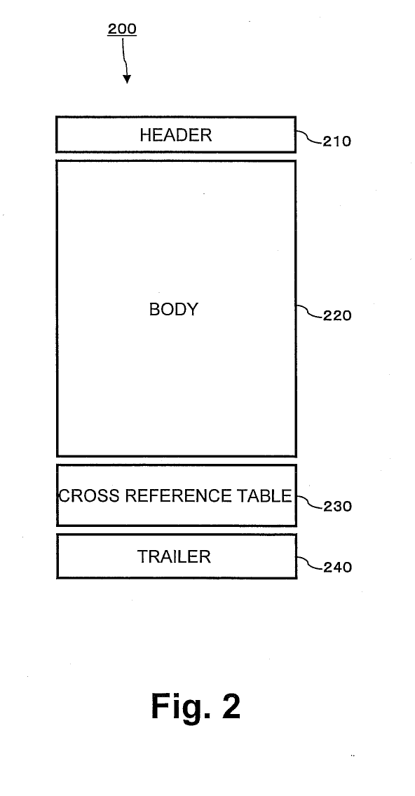

Here, the structure of a PDF file and an analysis method will be briefly described with reference to FIG. 2. As shown in FIG. 2, a PDF file 200 includes a header 210, a body 220, a cross reference table 230, and a trailer 240, and these are arranged in this sequence from the top of the file.

The header 210 is information indicating that the format of the file is PDF as well as the version of the PDF specification to which the file conforms.

The body 220 is information including objects constituting a document. Here, the objects are individual elements constituting the document, such as a document structure, page information, font information, and color information. In the body 220, each object is correlated with an ID number for identifying the object and is described.

The cross reference table 230 is reference information indicating the positions of the objects in the file. In the cross reference table 230, the position of an object having the specific ID number is expressed by a byte number (offset) from the top of the file to the top of the object. This enables random access to the objects arranged in the body 220.

The trailer 240 is information to be accessed at the time of analysis start of the file. Specifically, the information indicating the position of the cross reference table 230 in the file and the ID number of the object (root object as the root of a hierarchical structure) to which reference is to be made first are described in the trailer 240.

In the case where the PDF file having the above structure is analyzed, the trailer 240 at the end of the file is first analyzed, and next, the cross reference table 230 is analyzed. Then, the content of the page described in the body 220 is analyzed by reference to the information obtained by these analyses. The object includes an ID number of another object in which data that are required next are described. Thus, complete analysis of the PDF file becomes possible by tracking the ID number of the object required next. Since the ID number of the object to which reference is to be made next is indicated, the objects do not have to be arranged in sequence of analysis in the body of the PDF file. Accordingly, the objects can be described in an arbitrary sequence and in object units in the body of the PDF file, and as a result, they can be arranged in the file in a sequence different from the sequence of pages.

As stated above, in the case where the PDF file is analyzed, after the trailer 240 present in the vicinity of the end of the file and the cross reference table 230 are first analyzed, access must be made to the object in the body 220. Thus, a device for analyzing the PDF file can perform the analysis only after the entire PDF file is held in a memory device such as memory.

Returning to FIG. 1, the functional structure of the PC 1 and the controller 30 will be described.

The PC 1 includes, as functional blocks, a print instruction reception section 11, a print setting reception section 12, an extraction section 13, a job ticket creation section 14, and a transmission section 15. Incidentally, these functional blocks 11 to 15 are realized in such a manner that, for example, utility software is executed by the CPU.

The print instruction reception section 11 receives from the user a print instruction including the designation of a PDF file to be printed.

The print setting reception section 12 receives print settings from the user. As the print settings, various settings are widely known, and for example, settings relating to both sides, N-up, staple, punch, color, sort/stack, and the like can be named.

The extraction section 13 extracts the cross reference table and the trailer from the PDF file relating to the print instruction received by the print instruction reception section 11.

The job ticket creation section 14 creates print control information (hereinafter referred to as a “job ticket”) in which the print settings received by the print setting reception section 12 are described. In this exemplary embodiment, the job ticket creation section 14 embeds into the job ticket the cross reference table and the trailer extracted by the extraction section 13.

The transmission section 15 first transmits the cross reference table and the trailer extracted by the extraction section 13 to the printing apparatus 2, and then transmits the body of the PDF file. In this exemplary embodiment, the transmission section 15 transmits to the printing apparatus 2 the job ticket including the cross reference table and the trailer, which has been created by the job ticket creation section 14, and the PDF file itself, in this sequence.

The controller 30 includes, as functional blocks, a reception section 31 and a print control section 32.

The reception section 31 receives the cross reference table and the trailer of the PDF file to be printed from the transmission section 15 of the PC 1, and then receives the body of the PDF file. In this exemplary embodiment, the reception section 31 receives from the PC 1 the job ticket and the PDF file itself, in this sequence.

The print control section 32 starts the print processing of the PDF file to be printed without waiting for the completion of receipt of the body, by using the cross reference table and the trailer received by the reception section 31. In this exemplary embodiment, the print control section 32 analyzes the received body whenever necessary in accordance with the cross reference table and the trailer included in the job ticket without waiting for the completion of receipt of the PDF file sent subsequently to the job ticket, and controls the print section 20 to perform the print processing of the PDF file.

Hereinafter, the operation of the printing system 100 having the above structure is divided into an operation of the PC 1 and an operation of the printing apparatus 2 and will be described.

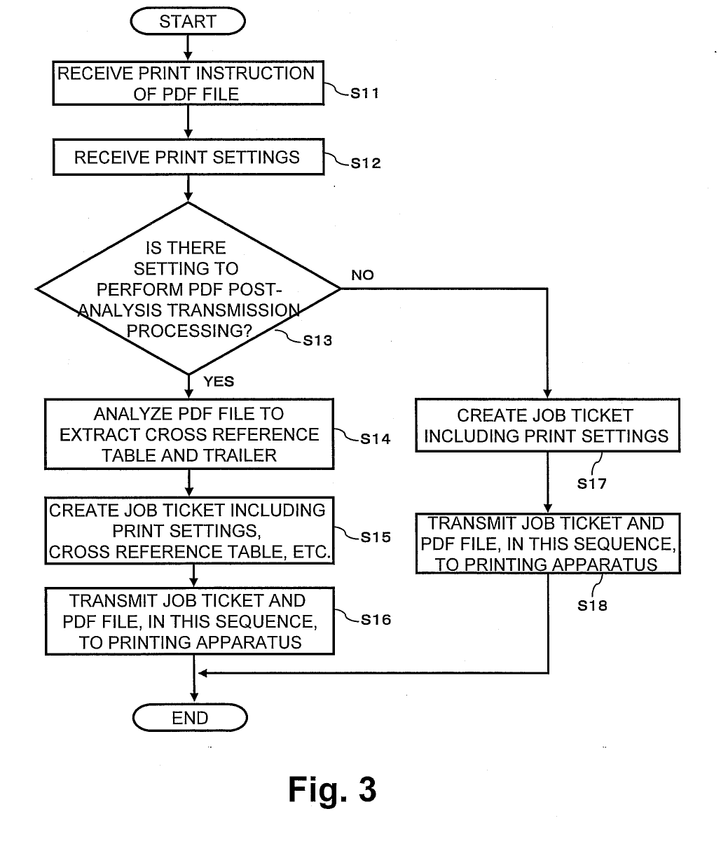

FIG. 3 is a flowchart showing the operation procedure of the PC 1. In FIG. 3, the PC 1 receives a print instruction of the PDF file (S11). For example, on the desktop screen of the PC 1, the user drags and drops an icon of the PDF file to be printed onto an icon of the utility software of direct print, and the PC 1 receives the user operation as the print instruction.

Next, the PC 1 causes the print setting screen to be displayed on the display screen, and receives the input of the print settings from the user through this print setting screen (S12). In this exemplary embodiment, through this print setting screen, the PC 1 receives from the user, as one of the print settings, a setting as to whether or not there is to be performed processing (hereinafter suitably referred to as “PDF post-analysis transmission processing”) for first transmitting the cross reference table and the trailer and then transmitting the body.

Next, the PC 1 judges in step S12 whether or not the setting to perform the PDF post-analysis transmission processing has been effected (S13).

In the case where it is judged that the setting to perform the PDF post-analysis transmission processing has been effected (S13: YES), the PC 1 analyzes the PDF file relating to the print instruction, and extracts the cross reference table and the trailer included in the PDF file (S14).

Next, the PC 1 creates the job ticket including the print settings input in step S12 and the cross reference table and the trailer extracted in step S14 (S15).

The PC 1 transmits to the printing apparatus 2 the created job ticket and the PDF file whose printing is instructed, in this sequence (S16).

On the other hand, in the case where the setting to perform the PDF post-analysis transmission processing has not been effected (S13: NO), the PC 1 creates the job ticket including the print settings input in step S12 (S17), and transmits to the printing apparatus 2 the job ticket and the PDF file whose printing is instructed, in this sequence (S18).

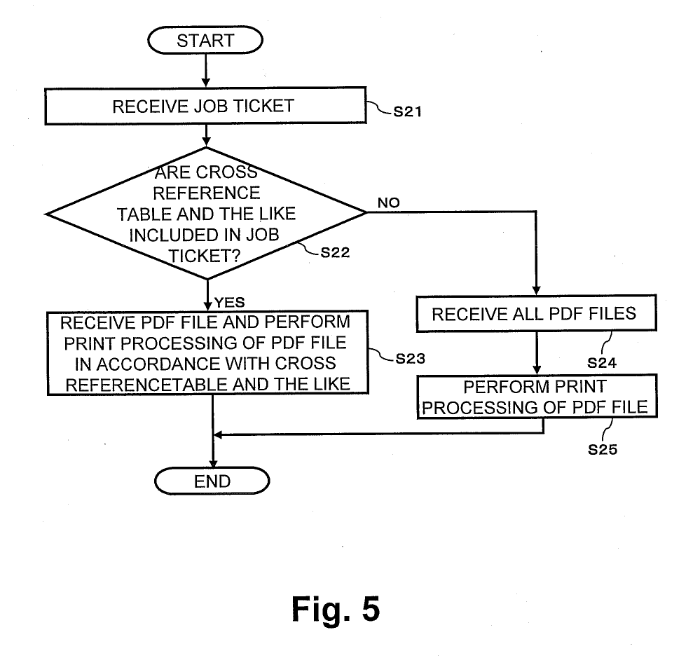

FIG. 5 is a flowchart showing the operation procedure of the printing apparatus 2. As shown in FIG. 5, upon receiving the job ticket from the PC 1 (S21), the printing apparatus 2 judges whether or not the cross reference table and the trailer are embedded in the job ticket (S22).

In the case where it is judged that the cross reference table and the like are embedded in the job ticket (S22: YES), while receiving the PDF file sent subsequently to the job ticket, the printing apparatus 2 performs the print processing of the PDF file in accordance with the cross reference table and the trailer included in the job ticket (S23). Specifically, without waiting for the completion of receipt of the PDF file, the printing apparatus 2 uses the cross reference table and the trailer included in the job ticket whenever necessary to analyze the received body, and creates raster data of each page. The printing apparatus 2 performs the print processing based on the created raster data whenever necessary in accordance with the print settings included in the job ticket. For example, in the case where the first to third pages of the PDF file are to be sequentially printed, the printing apparatus 2 operates as follows. When all objects necessary for drawing of the first page are completed, the printing apparatus 2 creates the raster data of the first page on the basis of these objects, and print-outputs the first page on the basis of the raster data. Next, the printing apparatus 2 sequentially print-outputs the second page and the third page in a similar manner to that of the first page.

On the other hand, in the case where it is judged that the cross reference table and the like are not embedded in the job ticket (S22: NO), the printing apparatus 2 receives all PDF files (S24), and then print-outputs the PDF files in accordance with the print settings included in the job ticket (S25).

Moreover, in the description, although the structure in which the entire PDF file is transmitted to the printing apparatus 2 subsequently to the job ticket has been exemplified, no limitation is made to this, and it may be the case that only the body is transmitted subsequently to the job ticket. Incidentally, the header may be transmitted immediately after or before the job ticket, or may be transmitted after being embedded in the job ticket.

In addition, the PC 1 may be constructed such that in the case where the capacity of the PDF file to be printed exceeds a specified capacity, the PDF post-analysis transmission processing is performed; otherwise, there is performed processing (hereinafter suitably referred to as “normal transmission processing”) in which the PDF file is transmitted to the printing apparatus 2 as is. Here, the specified capacity may be set by the user, or may be previously determined by the utility software.

Moreover, the PC1 may be constructed such that the capacity of the PDF file to be printed is compared with the memory capacity of the printing apparatus 2, and on the basis of this comparison result, a selection is made as to whether or not the PDF post-analysis transmission processing is to be performed. For example, in the case where the capacity of the PDF file exceeds the memory capacity of the printing apparatus 2, or exceeds the capacity of the specified ratio of the memory capacity, the PC1 performs the PDF post-analysis transmission processing; otherwise, it performs the normal transmission processing. Here, the PC 1 may acquire the memory capacity of the printing apparatus 2 by communication with the printing apparatus 2, or may receive input of the memory capacity from the user. Moreover, the memory capacity may be a fixed value or a dynamic value corresponding to the usage status of the memory.

In addition, the PC 1 may be constructed such that a judgment is made as to whether or not it is effective in shortening of the print time that the PDF post-analysis transmission processing is performed on the PDF file to be printed, and in the case where the judgment shows that it is effective, the PDF post-analysis transmission processing is performed; otherwise, the normal transmission processing is performed. Here, the print time is, for example, the time (so-called first print time) from the print instruction to the completion of the print output of the first page, or the time from the print instruction to the completion of printing of all pages. As a case in which performing the PDF post-analysis transmission processing is not effective in shortening of the print time, for example, there is a case in which an object of a page to be first printed is present at the end of the body.

Moreover, the printing apparatus starts the print processing of the PDF file without waiting for the completion of receipt of the body, print-outputs each page of the PDF file whenever necessary, and may delete from the memory area of the printing apparatus any object unnecessary for the print.

In addition, the technique relating to direct printing of the PDF file can be similarly applied to a document file in a file format similar to the PDF format. That is, the technique can be similarly applied to the document file in which information to be accessed at the time of analysis start of the document file can be arranged at a location other than at the top of the document file. In the case of such a document file, the information to be accessed at the time of analysis start of the document file is extracted from the document file, the extracted information is first transmitted to the printing apparatus, and then only the remaining data of the document file have to be transmitted.

The foregoing description of the exemplary embodiment of the present invention has been provided for the purpose of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

What is claimed is:

1. A printing system comprising an information processing apparatus and a printing apparatus, wherein
the information processing apparatus includes:
an extraction section that extracts a cross reference table and a trailer from a PDF file to be printed; and
a transmission section that first transmits the extracted cross reference table and the trailer to the printing apparatus, and then transmits a body of the PDF file, and wherein
the printing apparatus includes:
a reception section that receives the cross reference table and the trailer from the information processing apparatus and then receives the body; and
a print processing section that starts print processing of the PDF file without waiting for completion of receipt of the body, by using the received cross reference table and the trailer.

2. An information processing apparatus comprising:
an extraction section that extracts a cross reference table and a trailer from a PDF file to be printed; and
a transmission section that first transmits the extracted cross reference table and the trailer to a printing apparatus, and then transmits a body of the PDF file.

3. The information processing apparatus according to claim 2, wherein, on the basis of a user instruction, selection is made as to whether or not there is performed processing of first transmitting the cross reference table and the trailer and then transmitting the body.

4. The information processing apparatus according to claim 2, wherein in a case where a capacity of the PDF file exceeds a specified capacity, there is performed processing of first transmitting the cross reference table and the trailer and then transmitting the body.

5. The information processing apparatus according to claim 2, wherein a capacity of the PDF file and a memory capacity of the printing apparatus are compared with each other, and, on the basis of a comparison result, selection is made as to whether or not there is performed processing of first transmitting the cross reference table and the trailer and then transmitting the body.

6. The information processing apparatus according to claim 2, wherein a judgment is made as to whether or not a processing of first transmitting the cross reference table and the trailer and then transmitting the body is effective in shortening of a print time, and in a case where the result of judgment shows that such processing is effective, the processing is performed.

7. A printing apparatus comprising:
a reception section that receives, from an information processing apparatus, a cross reference table and a trailer of a PDF file to be printed and then receives a body of the PDF file; and
a print processing section that starts print processing of the PDF file without waiting for completion of receipt of the body, by using the received cross reference table and the trailer.

8. A method of printing a PDF file, comprising:
extracting a cross reference table and a trailer from a PDF file to be printed;
transmitting the extracted cross reference table and the trailer first to a printing apparatus, and then transmitting a body of the PDF file;
receiving the cross reference table and the trailer and then receiving the body; and
starting print processing of the PDF file without waiting for completion of receipt of the body, by using the received cross reference table and the trailer.

9. A method for transmitting a PDF file to a printing apparatus, comprising:
extracting a cross reference table and a trailer from the PDF file to be printed; and
transmitting the extracted cross reference table and the trailer first to the printing apparatus, and then transmitting a body of the PDF file.

10. A method for printing a PDF file, comprising:
receiving, from an information-processing apparatus, a cross reference table and a trailer of a PDF file to be printed and then receiving a body of the PDF file; and
starting print processing of the PDF file without waiting for completion of receipt of the body, by using the received cross reference table and the trailer.

11. A computer readable medium storing a program causing a computer to execute a process for transmitting a PDF file to a printing apparatus, the process comprising:
extracting a cross reference table and a trailer from the PDF file to be printed; and
transmitting the extracted cross reference table and the trailer first to the printing apparatus, and then transmitting a body of the PDF file.

12. A computer readable medium storing a program causing a computer to execute a process for printing a PDF file, the process comprising:
receiving, from an information-processing apparatus, a cross reference table and a trailer of a PDF file to be printed and then receiving a body of the PDF file; and
starting print processing of the PDF file without waiting for completion of receipt of the body, by using the received cross reference table and the trailer.

13. A computer data signal embodied in a carrier wave for enabling a computer to perform a process for transmitting a PDF file to a printing apparatus, the process comprising:
extracting a cross reference table and a trailer from the PDF file to be printed; and
transmitting the extracted cross reference table and the trailer first to the printing apparatus, and then transmitting a body of the PDF file.

14. A computer data signal embodied in a carrier wave for enabling a computer to perform a process for printing a PDF file, the process comprising:
receiving, from an information-processing apparatus, a cross reference table and a trailer of a PDF file to be printed and then receiving a body of the PDF file; and
starting print processing of the PDF file without waiting for completion of receipt of the body, by using the received cross reference table and the trailer.
